(19) United States
(12) Patent Application Publication
(10) Pub. No.: US 2014/0097693 A1
(43) Pub. Date: Apr. 10, 2014

(54) ELECTRICAL FEEDING DEVICE

(71) Applicant: SIEMENS AKTIENGESELLSCHAFT, MUENCHEN (DE)

(72) Inventor: Holger Leu, Uttenreuth (DE)

(73) Assignee: SIEMENS AKTIENGESELLSCHAFT, MUENCHEN (DE)

(21) Appl. No.: 14/117,880

(22) PCT Filed: May 24, 2011
(86) PCT No.: PCT/EP2011/058438

§ 371 Date: Nov. 15, 2013

(51) Int. Cl. H02J 9/04

(52) U.S. Cl. CPC H02J 9/04
USPC 307/66

(57) ABSTRACT

An electrical feeding device has at least one feed connection at which electrical power can be fed into the feeding device and/or electrical power can be tapped from the feeding device. A converter has at least one a.c. voltage connection at which an alternating current can be fed in or tapped and at least one d.c. voltage connection at which a direct current can be fed in or tapped. A power module is connected to the d.c. voltage connection of the converter. A switchable transformer device, by means of which the input voltage present at the feed connection of the feeding device can be transformed down to a lower voltage for the converter, is electrically switched between the feed connection of the feeding device and the a.c. voltage connection of the converter.

The invention relates to an electrical feeding device having at least one feed connection at which electrical power can be fed into the feeding device and/or electrical power can be tapped from the feeding device, having a converter which has at least one a.c. voltage connection at which an alternating current can be fed in or tapped, and at least one d.c. voltage connection at which a direct current can be fed in or tapped, and a power module connected to the d.c. voltage connection of the converter. The power module in question can for example be a power source, for example in the form of a power storage device or a power generator.

The object of the invention is to increase the range of operation in the case of a feeding device of the type described.

This object is achieved according to the invention by a feeding device having the features described in claim 1. Advantageous embodiments of the feeding device according to the invention are described in subclaims.

Provision is accordingly made according to the invention that a switchable transformer device, which is able to transform the input voltage present at the feed connection of the feeding device down to a lower voltage for the converter, is electrically switched between the feed connection of the feeding device and the a.c. voltage connection of the converter.

An important advantage of the feeding device according to the invention consists in an increased range of operation for the power module in comparison with feeding devices without a switchable transformer device. In the case of a feeding device without the switchable transformer device provided according to the invention the range of operation of the power module is limited by the mode of operation of the converter. The upper limit Udcmax of the d.c. voltage Udc at the d.c. voltage connection of the converter is limited by the voltage load capability of the components of the converter; the lower limit Udcmin of the d.c. voltage Udc at the d.c. voltage connection of the converter is determined by a.c. voltage Uac at the a.c. voltage connection of the converter, where the following applies:

Udcmin=√2*Uac

On account of said restrictions the d.c. voltage at the power module in the case of a feeding device without switchable transformer device can only fluctuate in a voltage range between Udcmax and √2*Uac. The voltage range in which many power modules can operate is however often greater. This is the starting point for the invention in that according to the invention it is proposed to provide a switchable transformer device which can temporarily transform the input voltage present at the feed connection of the feeding device down to a lower voltage for the converter. As a result of temporarily transforming down the voltage Uac at the a.c. voltage connection of the converter it is possible to increase the range of operation of the power module even though the range of operation of the converter is limited and remains limited; this will be described in brief with reference to an example. If the converter is a conventional IGBT-based 2-point converter, then the upper limit Udcmax of the d.c. voltage Udc at the d.c. voltage connection of the converter is limited to approx. 1200V. If an a.c. voltage Uac at the a.c. voltage connection of 650V is assumed for example, then the lower limit Udcmin of the d.c. voltage Udc at the output of the converter is determined as 650V*√2=920V. The range of operation of the power module is therefore limited to the range between 1200V and 920V even though the power module could under certain circumstances also be operated in a range below 920V. If the transformer device proposed according to the invention is now—for example on reaching the lower voltage limit of 920V—switched on or switched over and the a.c. voltage is temporarily transformed down, for example by the factor √3, then the lower limit Udcmin of the d.c. voltage Udc at the d.c. voltage connection of the converter is reduced to 650V*√2/√3=530V. By switching on or switching over the transformer provided according to the invention the range of operation of the power module is therefore increased to a range between 1200V and 530V (contrasted with a range between 1200V and 920V without a switchable transformer device).

It is for example possible to switch the transformer device on and off in order to enable the temporary changeover of the range of operation for the power module. It is however regarded as particularly advantageous if the transformer device can be switched over, namely in such a manner that optionally depending on the switch position at least two different voltage levels are available on the secondary side. With regard to the last-mentioned embodiment, one switch position can for example be provided in the case of a high voltage at the power module and another switch position in the case of a lower voltage in comparison at the power module.

The changeover of the transformer device preferably takes place by means of a control device which is connected with the transformer device. By preference the control device measures the voltage at the power module or the voltage at the d.c. voltage connection of the converter (or a voltage proportional to the aforesaid voltages) and sets the switch position of the transformer device depending on the voltage.

The transformer device is preferably three-phase and can optionally be switched on the secondary side into a star connection or into a delta connection. In an advantageous manner the transformer can deliver the same output both in the star connection and also in the delta connection; in this situation the transformer device can be switched over without there being a need to change anything regarding the numbers of windings of the transformer device.

In the latter case it is regarded as advantageous if the control device is designed in such a manner that it switches the transformer device on the secondary side into the star connection when the voltage at the power module or the voltage at the d.c. voltage connection of the converter (or a voltage proportional to the aforesaid voltages) exceeds a predefined first threshold value, and switches the transformer device on the secondary side into the delta connection when the voltage at the power module or the voltage at the d.c. voltage connection of the converter (or a voltage proportional to the aforesaid voltages) undershoots a predefined second threshold value.

The first threshold value and the second threshold value can for example be identical. By preference the first threshold value is however greater than the second threshold value; this enables a type of “hysteresis behavior” on switchover.

It is also alternatively or additionally possible to switch over the transformer device in such a manner that depending on the switch position at least two different transformation ratios are optionally available between primary side and secondary side. The concept “transformation ratio” is understood here for example to be the ratio between the voltage on the primary side and the voltage on the secondary side.

By preference the control device is designed in such a manner that it increases the transformation ratio when the voltage at the power module or the voltage at the d.c. voltage connection of the converter undershoots a predefined threshold value.

The primary side of the transformer device is preferably switched into a delta connection, although a star connection is also possible on the primary side.

A filter is preferably electrically switched between the secondary side of the transformer device and the a.c. voltage connection of the converter. The filter preferably suppresses noise frequencies which are generated by the converter.

The power module in question is preferably a power source, in particular in the form of a power storage device or a power generator.

If the power module in question is a power storage device, then it is regarded as advantageous if the power storage device is an electrical storage device, for example an electrochemical or an electromechanical power storage device. The power storage device can for example comprise at least one primary element, in other words a non-rechargeable element, and/or at least one secondary element, in other words a rechargeable element.

In the case of an electrochemical power storage device it is regarded as advantageous if the power storage device at least also comprises one or more of the following battery types: lithium-ion battery, lithium iron phosphate battery, lithium polymer battery, lead battery, NiCd battery, NiMH battery, high temperature battery, NaS battery, Zebra battery, sodium-air battery.

The power storage devices are preferably equipped with an individual control algorithm and/or an individual balun.

Alternatively or in addition, a power storage device can comprise a capacitor, in particular a double-layer capacitor or a hybrid capacitor.

If the power module in question is a power source, it is regarded as advantageous if said power source comprises a photovoltaic system and/or a wind generator and/or a fuel cell.

With regard to the converter of the feeding device, it is regarded as advantageous if said converter is a two-point converter, a three-point converter or a multilevel converter, for example a converter based on Marquardt topology.

The feeding device described above can for example be employed in the case of electric vehicles in order to temporarily store power and subsequently to make said power available for drive purposes.

The invention moreover relates to a power distribution system for supplying a supply area with electrical power, wherein the power distribution system has at least one feeding device as has been described above.

With regard to the advantages of the power distribution system according to the invention, reference should be made to the advantages described above of the feeding device according to the invention, since the advantages of the feeding device according to the invention essentially correspond to those of the power distribution system according to the invention.

The invention moreover relates to a method for operating a feeding device as has been described above. According to the invention, provision is made that the voltage at the power module or the voltage at the d.c. voltage connection of the converter (or a voltage proportional to the aforesaid voltages) is measured and the transformer device is set depending on the voltage. With regard to the advantages of the method according to the invention, reference should be made to the advantages described above of the feeding device according to the invention, since the advantages of the feeding device according to the invention essentially correspond to those of the method according to the invention.

It is regarded as advantageous if the transformer device is switched on the secondary side into the star connection when the voltage at the power module or the voltage at the d.c. voltage connection of the converter (or a voltage proportional to the aforesaid voltages) exceeds a predefined first threshold value, and the transformer device is switched on the secondary side into the delta connection when the voltage at the power module or the voltage at the d.c. voltage connection of the converter (or a voltage proportional to the aforesaid voltages) undershoots a predefined second threshold value.

The invention will be described in detail in the following with reference to exemplary embodiments; in the drawings, by way of example:

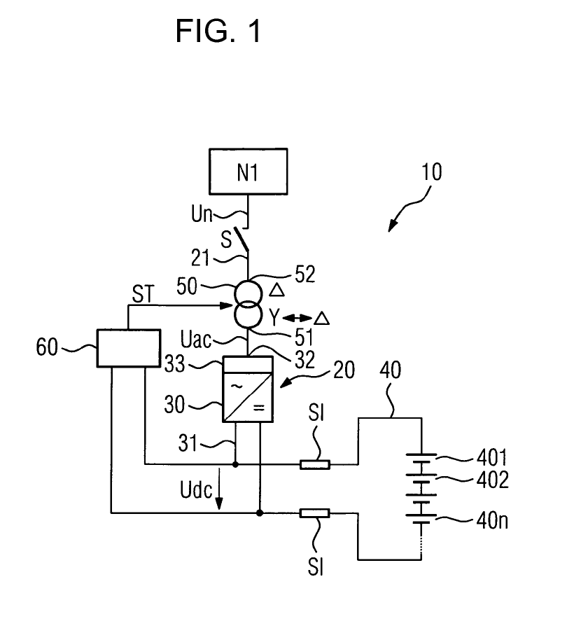

FIG. 1 shows a first exemplary embodiment of a power distribution system according to the invention which comprises an exemplary embodiment of a feeding device according to the invention,

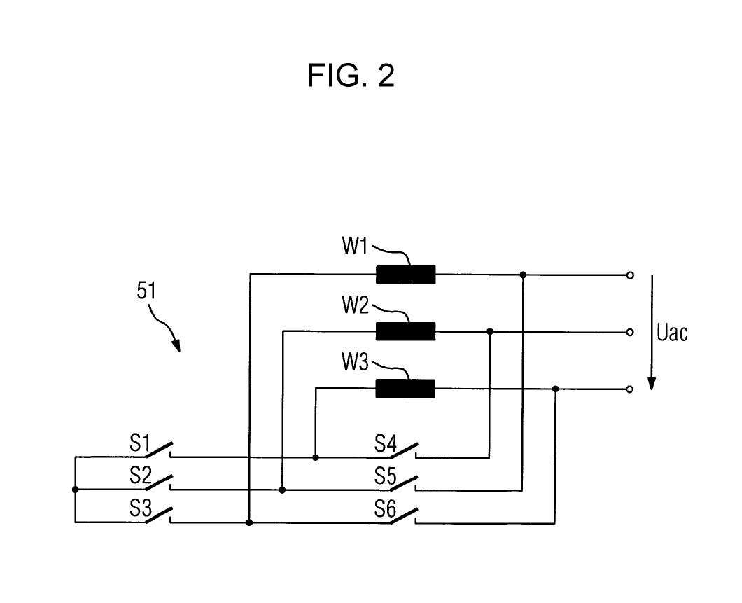

FIG. 2 shows a detailed view of the secondary side of a transformer of the feeding device according to FIG. 1,

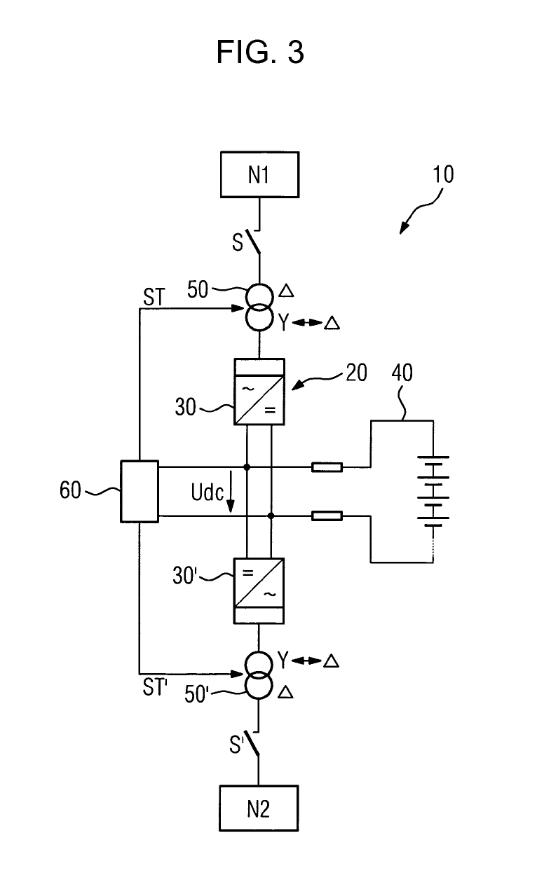

FIG. 3 shows a second exemplary embodiment of a power distribution system according to the invention in which the feeding device has a power module, two converters and two transformers,

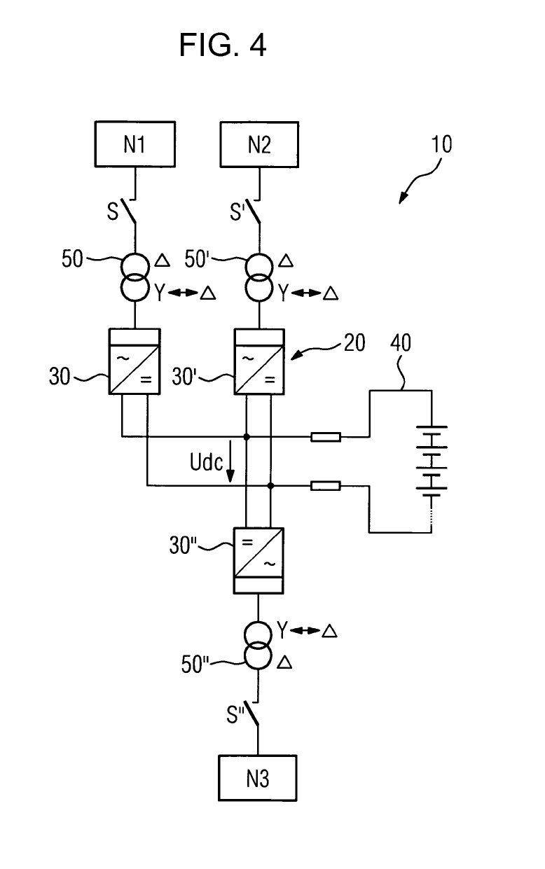

FIG. 4 shows a third exemplary embodiment of a power distribution system according to the invention in which the feeding device has a power module, three converters and three transformers,

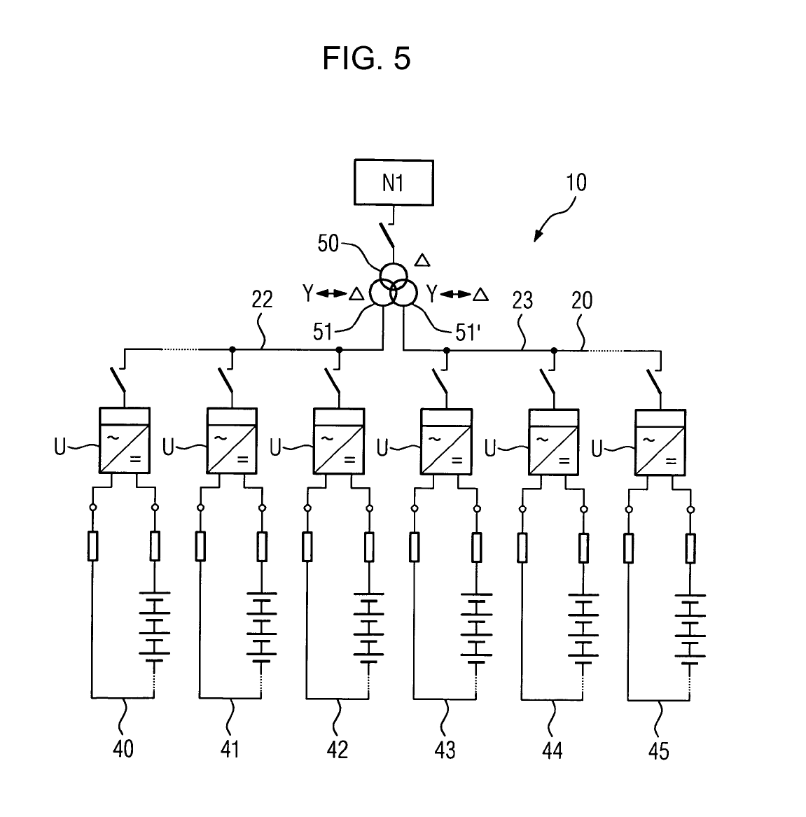

FIG. 5 shows a fourth exemplary embodiment of a power distribution system according to the invention in which the transformer of the feeding device has two separate trains on the secondary side, each of which is connected to a plurality of power modules, and

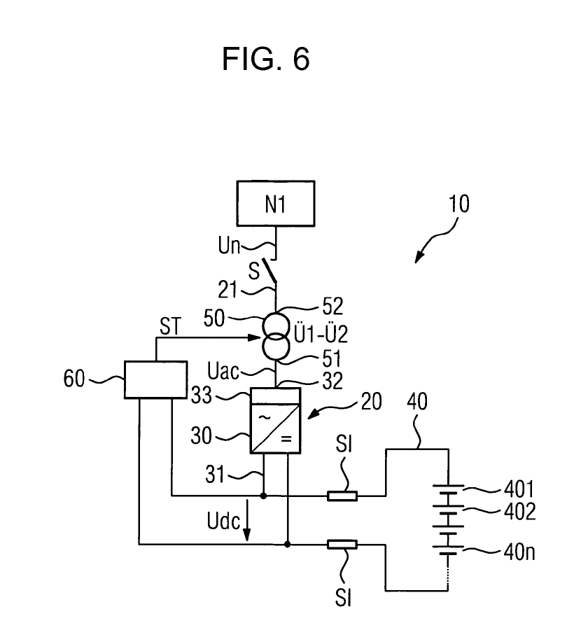

FIG. 6 shows a fifth exemplary embodiment of a power distribution system according to the invention in which the transformer can be switched in respect of its turns ratios.

In the figures, for the sake of clarity, the same reference characters are always used for identical or comparable components.

FIG. 1 shows a power distribution system 10 which is equipped with a feeding device 20. The feeding device 20 is used in order to feed electrical power into and out of the power distribution system 10 and has a feed connection 21 which is connected by way of a switch S with a power supply network N1. Power can be fed by way of the feed connection 21 into the feeding device 20 or taken (tapped) from said feeding device 20.

The feeding device 20 has a converter 30, the d.c. voltage connection 31 of which is connected to a power module 40. The power module 40 in question can for example be a power storage device which has a multiplicity of storage cells. It is assumed by way of example in the following that the power module 40 has two hundred and eighty lithium-ion storage cells which due to technical considerations can each have a cell voltage of between 2V and 4.2V.

Of the total of two hundred and eighty storage cells three are shown by way of illustration in FIG. 1 and denoted by the reference characters 401, 402 and 40n. The connection of the power module 40 to the d.c. voltage connection 31 of the converter 30 can for example take place by way of fuses SI, as is shown in FIG. 1.

A switchable transformer device 50 is connected by its secondary side 51 to the a.c. voltage connection 32 of the converter 30. The primary side 52 of the switchable transformer device 50 is connected with the feed connection 21 of the feeding device 20.

The a.c. voltage present at the a.c. voltage connection 32 of the converter 30 and thus on the secondary side 51 of the transformer device 50 is identified in FIG. 1 by the reference character Uac. The d.c. voltage present at the d.c. voltage connection 31 and thus at the power module 40 is identified in FIG. 1 by the reference character Udc.

The converter 30 can be equipped with a filter 33 which suppresses the noise frequencies generated by the converter 30 (normally in the kilohertz range). Such a filter 33 can form a part of the converter 30 (as shown in FIG. 1) or can be a separate component.

FIG. 1 furthermore shows a control device 60 which measures the d.c. voltage Udc at the d.c. voltage connection 31 of the converter 30 and thus the voltage at the power module 40. The control device 60 evaluates the respective voltage measurement value and controls the switchable transformer device 50 accordingly, as will be explained below in further detail.

The switchable transformer device 50 is switched on its primary side 52 into a delta connection, as is symbolized in FIG. 1 by a small triangle in the region of the primary side 52 of the transformer device 50. The transformer device 50 can be switched over on the secondary side 51, namely from a star connection into a delta connection and vice versa; this is indicated in FIG. 1 by means of corresponding symbols.

The switchover of the transformer device 50 from the star connection into the delta connection or from the delta connection into the star connection is initiated by the control device 60 by means of a corresponding control signal ST.

The control device 60 compares the d.c. voltage Udc at the d.c. voltage connection 31 of the converter 30 or at the power module 40 with a predefined first and a predefined second threshold value and switches the transformer device 50 into the star connection or into the delta connection depending on the d.c. voltage measurement value.

The control device 60 will preferably switch the transformer device 50 on the secondary side 51 into the star connection when the d.c. voltage Udc at the power module 40 exceeds the predefined first threshold value.

The transformer device 50 is preferably switched by the control device 60 from the star connection into the delta connection when the d.c. voltage Udc at the power module 40 undershoots a predefined second threshold value. The first threshold value is preferably greater than the second threshold value, which means that a hysteresis behavior is achieved on switching.

It is assumed by way of example for the purpose of the further descriptions that the transformer device 50 in the star connection generates an a.c. voltage Uac at a level of 650V on account of the line voltage Un present at the power supply network N1. In this case, for reliable operation of the converter 30 the d.c. voltage Udc at the d.c. voltage connection 31 of the converter or at the power module 40 should always be at least as great as the “absolute” intermediate circuit minimum voltage of 920V, which corresponds to √2 times 650V.

If for safety reasons a minimum d.c. voltage Udcmin at a level of 950V is assumed, then the 280 lithium-ion storage cells 401, 402 . . . 40n can be discharged down to a lower cell voltage of 3.4V(=950V/280). With the transformer in a star connection the operating range of the storage cells therefore lies between 3.4V and 4.2V.

In order to be able to force the operating range of the storage cells into a range below 3.4V the control device 60 will then switch the transformer device 50 over from the star connection into the delta connection at the latest at the point when the d.c. voltage Udc reaches the value of 950V. The voltage value of 950V thus forms the aforesaid “second” threshold value.

By switching the transformer over into the delta connection the resulting a.c. voltage Uac at the a.c. voltage connection 32 of the converter 30 is reduced to a value of 375V(=650V/√3), which means that the “absolute” intermediate circuit minimum voltage is correspondingly reduced to a value of 530V(=375V*√2). If for safety reasons a minimum operating intermediate circuit minimum voltage Udcmin of 560V is assumed, then the 280 lithium-ion storage cells can be discharged down to a voltage of 2V(=560V/280). The operating range of the lithium-ion storage cells is therefore increased to a voltage range of between 2V and 4.2V.

If the d.c. voltage Udc at the d.c. voltage connection 31 again exceeds an upper voltage limit of for example 955V (“first” threshold value) in the case of a subsequent charging of the lithium-ion storage cells of the power module 40, then the transformer device 50 is switched back again from the delta connection into the star connection in order to make available the upper voltage range for the lithium-ion storage cells whilst guaranteeing a good degree of efficiency for the feeding device 20.

FIG. 2 shows by way of example the secondary side 51 of the transformer device 50 according to FIG. 1. It can be seen that the three windings W1, W2 and W3 are connected with six switches S1, S2, S3, S4, S5 and S6. If the three switches S1, S2 and S3 are switched on and the switches S4, S5 and S6 opened, then the secondary side 51 of the transformer device 50 is operated in a star connection. If on the other hand the switches S1, S2 and S3 are opened and the switches S4, S5 and S6 are closed, then the secondary side 51 is operated in a delta connection.

In order to switch the transformer device 50 over from the star connection into the delta connection and conversely from the delta connection into the star connection the six switches S1 to S6 are switched on or off as the case may be by the control device 60 by way of corresponding control signals ST, as has already been described in connection with FIG. 1.

FIG. 3 shows an exemplary embodiment of a power distribution system 10 in which two converters 30 and 30′ and also two transformer devices 50 and 50′ are connected to a power module 40. The transformer devices 50 and 50′ are switched by a control device 60 by means of control signals ST and ST′ optionally into the delta connection or into the star connection, in which case the particular switching state is dependent on the d.c. voltage Udc at the power module 40, as has already been described in connection with FIG. 1.

Through the two transformer devices 50 and 50′ the feeding device 20 according to FIG. 3 can be connected to two power supply networks N1 and N2 by switching the corresponding switches S and S′ on or off.

FIG. 4 shows an exemplary embodiment of a power distribution system in which the feeding device 20 has a power module 40 and also three converters 30, 30′ and 30″ and three switchable transformer devices 50, 50′ and 50″. By way of corresponding switches S, S′ and S″ the feeding device 20 can optionally be connected to a total of three power supply networks N1, N2 and N3. The switchover of the switchable transformer devices 50, 50′ and 50″ takes place by way of a control device, not shown in FIG. 4 for reasons of clarity, depending on the d.c. voltage Udc at the power module 40.

FIG. 5 shows an exemplary embodiment of a power distribution system 10 in which a feeding device 20 has a plurality of power modules 40, 41, 42, 43, 44 and 45, each of which is connected by way of associated converters U to a switchable transformer device 50. In contrast to the transformer devices according to FIGS. 1 to 4 the transformer device 50 according to FIG. 5 has two secondary sides 51 and 51′, to which an individual feed train 22 and 23 is connected in each case. The three power modules 40, 41 and 42 are connected to the left-hand feed train 22 in FIG. 5; the power modules 43, 44 and 45 are connected to the right-hand feed train 23 in FIG. 5.

The arrangement according to FIG. 5 enables the transformer device 50 to be switched over in uninterruptible fashion. That is to say, the two feed trains 22 and 23 are preferably not switched over simultaneously from a star connection into a delta connection or conversely from a delta connection into a star connection, but with a temporal offset. Switching the two secondary sides 51 and 51′ over with a temporal offset means that a voltage drop can be avoided.

FIG. 6 shows by way of example an arrangement 10 having a feeding device 20 in which the transformer device 50 is not switched by the control device 60 from a delta connection into a star connection and vice versa but instead the transformation ratio U is switched over (for example by connecting or disconnecting transformer windings). The concept “transformation ratio” is understood here for example to be the ratio between the voltage on the primary side and the voltage on the secondary side.

The transformer device 50 makes available for example two different transformation ratios Ü1 and Ü2 which can be selected optionally by the control device 60.

In the case of a transformation ratio Ü1 the transformer device 50 can for example generate an a.c. voltage Uac at a level of 650V on account of the line voltage Un present at the power supply network N1; in the case of a transformation ratio Ü2 the a.c. voltage Uac can for example be 375V(=650V/√3). The following therefore applies:

Ü1/Ü2=√3

The remainder of the mode of operation of the arrangement according to FIG. 6 corresponds to the arrangement according to FIG. 1, which means that reference should be made to the above information in this regard.

Although the invention has been illustrated and described in detail by means of the preferred exemplary embodiments, the invention is not restricted by the disclosed examples and other variations can be derived herefrom by the person skilled in the art without departing from the scope of protection of the invention.

1-11. (canceled)

12. An electrical feeding device, comprising:
at least one feed connection configured to enable electrical power to be fed into the feeding device and/or electrical power to be tapped from the feeding device;
a converter having at least one a.c. voltage connection at which an alternating current can be fed in or tapped, and at least one d.c. voltage connection at which a direct current can be fed in or tapped;
a power module connected to said d.c. voltage connection of said converter; and
a switchable transformer device electrically switched between said feed connection of the feeding device and said a.c. voltage connection of said converter, said transformer device being configured for transforming an input voltage present at said feed connection down to a lower voltage for said converter.

13. The feeding device according to claim 12, wherein said transformer device is switchable to selectively provide at least two different voltage levels on a secondary side thereof.

14. The feeding device according to claim 13, which comprises a control device for measuring a voltage at the d.c. voltage connection of said converter and/or a voltage at said power module and setting a switch position of said transformer device depending on the voltage connected with said transformer device.

15. The feeding device according to claim 14, wherein said transformer device is a three-phase transformer configured for selective switching on the secondary side into a star connection or a delta connection.

16. The feeding device according to claim 15, wherein said control device is configured to:
switch said transformer device on the secondary side into the star connection when the voltage at the d.c. voltage connection of the converter or the voltage at the power module exceeds a predefined first threshold value; and
switch said transformer device on the secondary side into the delta connection when the voltage at the d.c. voltage connection of the converter or the voltage at the power module undershoots a predefined second threshold value.

17. The feeding device according to claim 16, wherein the first threshold value is greater than the second threshold value.

18. The feeding device according to claim 16, wherein said transformer device is switchable to render available at least two different transformation ratios between a primary side and the secondary side, and said control device is configured to increase the transformation ratio when the voltage at said d.c. voltage connection of said converter or the voltage at said power module undershoots a predefined threshold value.

19. The feeding device according to claim 12, wherein said transformer device is switchable to render available at least two different transformation ratios between a primary side and the secondary side.

20. The feeding device according to claim 19, wherein said transformer is switched to increase the transformation ratio when the voltage at said d.c. voltage connection of said converter or the voltage at said power module undershoots a predefined threshold value.

21. A power distribution system for supplying a supply area with electrical power, comprising: at least one feeding device according to claim 12.

22. A method, comprising:
providing a feeding device according to claim 12;
measuring the voltage at the d.c. voltage connection of the converter or the voltage at the power module; and
setting the transformer device depending on the voltage measured in the measuring step.

23. The method according to claim 22, which comprises:
when the voltage at the d.c. voltage connection of the converter or the voltage at the power module exceeds a predefined first threshold value, switching the transformer device on the secondary side into a star connection; and
when the voltage at the d.c. voltage connection of the converter or the voltage at the power module undershoots a predefined second threshold value, switching the transformer device on the secondary side into a delta connection.
